(19) United States
(12) Patent Application Publication
(10) Pub. No.: US 2020/0027367 A1
(43) Pub. Date: Jan. 23, 2020

(54) REMOTE CONTROL OF LESSON SOFTWARE BY TEACHER

(71) Applicant: MCCARTHY MUSIC CORP., Seattle, WA (US)

(72) Inventors: Kevin Michael McCarthy, Seattle, WA (US); John Gilmore, Seattle, WA (US); Jason Michael McVey, Seattle, WA (US)

(21) Appl. No.: 16/474,537

(22) PCT Filed: Dec. 29, 2017
(86) PCT No.: PCT/US17/69082

§ 371 Date: Jun. 27, 2019

Related U.S. Application Data
(60) Provisional application No. 62/441,029, filed on Dec. 30, 2016.

(51) Int. Cl. G09B 15/00; G09B 15/08; G09B 15/04

(52) U.S. Cl. CPC G09B 15/003; G09B 15/04; G09B 15/08

(57) ABSTRACT

A system, comprising one or more processors; and memory storing instructions executable by the one or more processors to causes the system to associate together streams of data from at least three devices separated by a network, the at least three devices comprising a first device of a first user, a second device of the first user, and a third device of a second user, wherein association of the streams of data together enables the first device to receive data from the third device and the third device to receive data from the first device and the second device, wherein the data from the first device and the second device indicate playing of a first musical instrument by the first user and the data from the third device indicates playing of a second musical instrument by the second user, update a first user interface of the first device according to an event that occurred on the third device, and update a second user interface of the third device according to an event that occurred on the third device.

### CROSS-REFERENCE TO RELATED APPLICATIONS

This application incorporates by reference for all purposes the full disclosures of U.S. Pat. No. 8,901,405, issued Dec. 2, 2014, entitled “ELECTRONIC PIANO TRAINING DEVICE” and U.S. Pat. No. 9,082,313, issued Jul. 14, 2015, entitled “INTERACTIVE PIANO TRAINING SYSTEM.”

### DESCRIPTION OF THE FIGURES

FIG. 1 shows an illustrative example of an environment 100 in which various embodiments of the present disclosure may be implemented;

FIG. 2 shows an overview of the teacher and student environment in accordance with an embodiment;

FIG. 3 shows an illustrative environment of teacher software in accordance with an embodiment;

FIG. 4 illustrates an example diagram 400 showing the structure of lesson elements for lessons in accordance with an embodiment;

FIG. 5 shows an illustrative example in a teacher song assignment screen in accordance with an embodiment;

FIG. 6 shows demonstrates an example finger numbering system used for piano or other musical instrument instruction in accordance with an embodiment;

FIG. 7 illustrates a sample digital score in accordance with an embodiment;

FIG. 8 shows a live lesson process in accordance with an embodiment;

FIG. 9 shows a setup process for establishing a video, audio, and data link between devices in accordance with an embodiment;

FIG. 10 shows an embodiment for allowing multiple cameras to be used in an online environment;

FIG. 11 shows a process used when the student plays a piece of music in accordance with an embodiment;

FIG. 12 shows a process for a teacher demonstration in accordance with an embodiment;

FIG. 13 shows a setup screen in accordance with an embodiment;

FIG. 14 shows messages sent between devices in accordance with an embodiment; and

FIG. 15 shows an example computing device that may be used to implement various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

In an embodiment, a system comprises one or more processors and memory storing instructions executable by the one or more processors to causes the system to associate together streams of data from at least three devices separated by a network, the at least three devices comprising a first device of a first user, a second device of the first user, and a third device of a second user, wherein association of the streams of data together enables the first device to receive data from the third device and the third device to receive data from the first device and the second device, wherein the data from the first device and the second device indicate playing of a first musical instrument by the first user and the data from the third device indicates playing of a second musical instrument by the second user. In some embodiments, the memory is further executable to update a first user interface of the first device according to an event that occurred on the third device and/or update a second user interface of the third device according to an event that occurred on the third device. Updates to the user interfaces may be accomplished in various ways, such as by the transmission of messages over a network that, when received by the respective devices, cause the respective devices to update according to the messages.

Numerous variations are considered as being within the scope of the present disclosure. In an embodiment, for example, at least one of the streams of data comprises messages generated as a result of activation of switches of the first musical instrument or second musical instrument. A first stream of the streams may comprise messages generated as a result of activation of switches of the first musical instrument and a second stream of the streams comprises messages generated as a result of activation of switches of the second musical instrument. As another example, the streams of data may comprise messages that cause the first musical instrument to indicate notes played by the second musical instrument. Further, the streams of data may comprise messages that cause the second musical instrument to indicate notes played by the first musical instrument. In one implementation, first musical instrument and second musical instrument comprise electronic piano keyboards, although the techniques of the present disclosure are applicable to other types of musical instruments.

As further examples of variations falling within the scope of the present disclosure, in an embodiment, the instructions are further executable to cause the first device to display a code to be captured by the second device to enable a data stream of the first device to be associated with a data stream of the first device. As another example, the first user interface of the first device may be usable (e.g., through manipulation of the interface through an input device) to configure parameters for a lesson to cause the second user interface to update in accordance with parameters set on the first user interface. In an embodiment, the second user interface of the second device enables selection from multiple video streams for display. In some implementations, the instructions are further executable to cause the system to associate a fourth data stream from a fourth device associated with a third user with the first data stream, second data stream, and third data stream such that one of the first device or third device receives the fourth data stream. At least one of the data streams may comprise fingering data that indicates finger positions for playing the first musical instrument or the second musical instrument. As another example, at least one of the data streams may comprise light hints data that causes the first musical instrument or the second musical instrument to indicate how to play the first musical instrument or the second musical instrument according to a musical score. In an embodiment, the instructions are further executable to transmit a notification to both the first device and the third device to enable the first device and third device to receive data streams from each other. Other variations that may be practiced include embodiments where the data streams comprise messages that cause keyboard keys to illuminate and where the data streams comprise messages that indicate levels of force applied to keys of the first musical instrument and/or second musical instrument.

Variations of the techniques described herein are also practicable separately or in combination. In some embodiments, systems falling within the scope of the present disclosure apply some, but not all, of the techniques described above and below. Further, embodiments of the present disclosure include non-transitory computer-readable storage media storing instructions executable by one or more processors of a computer system to cause the computer system to perform operations such as described above and below. Methods of providing lessons online comprising performing operations described above and below are also within the scope of the present disclosure.

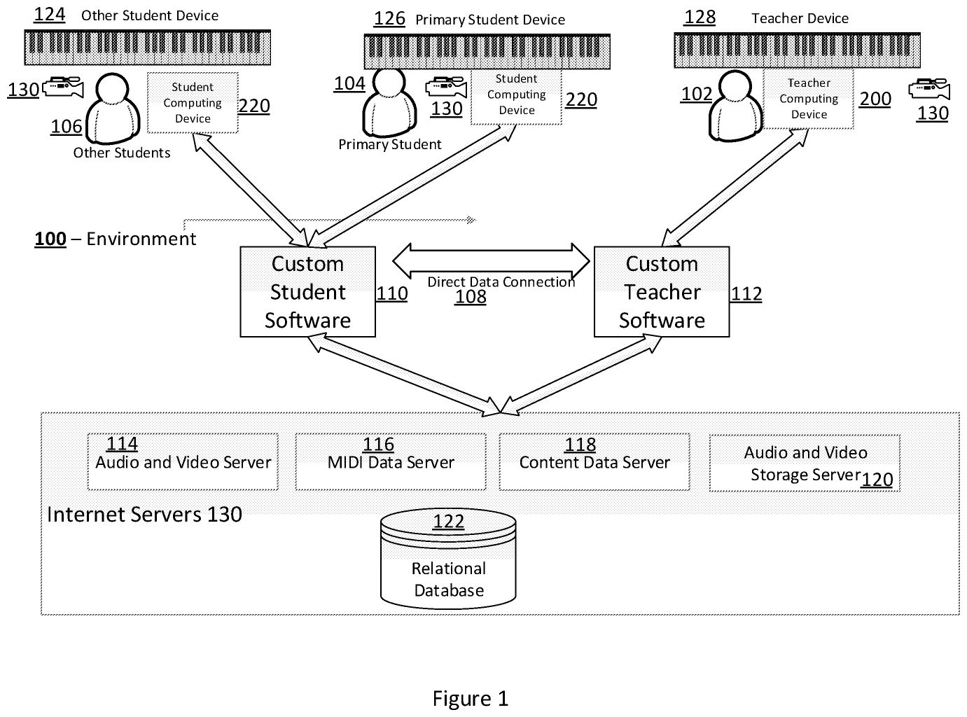

### Description of FIG. 1

FIG. 1 shows an illustrative example of an environment 100 in which various embodiments of the present disclosure may be implemented. In this example, a teacher 102 communicates with a primary student 104 over a direct data connection 108 for the purpose of instructing the primary student 104 how to play a musical instrument, such as the piano. The teacher 102, in this example, is real person who has expertise in a specific field, such as a piano teacher. This teacher 102 has training and skill in a specific field; in one example this teacher is an expert in playing the piano musical instrument. The primary student 104 is a real person who wishes to learn a skill from the teacher 102. The data connection 108 can also be described as a Circuit between two or more parties, which may be any combination of teachers and students. A Circuit it essentially a socket connection between two different IP addresses and port numbers. Establishing a Circuit connection between the student(s) and teacher(s) also data to transfer in real-time, directly between the parties. This is also depicted in 916.

The other students 106 are one or more additional real people who wish to learn skills from the teacher 102. This allows the system described herein, for example, to have a single primary student 104 in communication with a single teacher 102. In another embodiment, the teacher 102 could teach a primary student 104, as well as one or many other students 106. This allows the teacher to teach one student or many students simultaneously using the system described herein. In another embodiment, two or more teachers 102 could teach one primary student 104. In another embodiment, two or more teachers 102 could teach one primary student 104 and one or many other students 106. This would allow many teachers 102 to give a lesson to many students simultaneously, both primary student 104 and one or many other students 106.

In this example, the student uses a primary student device 126 and some custom student software 110 for the purpose of participating in a lesson. Similarly, the teacher 102 uses customer teacher software 112 and a teacher device 128 to communicate lessons to the primary student 104 and possibly other students 106.

The primary student device 126, in one embodiment, is a separate piece of hardware that the student uses. The primary student device 126 may have inputs and outputs (e.g., key presses and respective signals), which may be communicated through the custom student software 110 to other parts of the system. In one embodiment, the primary student device 126 could be an electronic keyboard style piano.

The other student device 124, in one embodiment, is a separate piece of hardware that the other students use. The other student device 126 may have inputs and outputs, which may be communicated through the custom student software 110 to other parts of the system. In one embodiment, the other student device 126 could be an electronic keyboard style piano.

The teacher device 128, in one embodiment, is a separate piece of hardware that the teacher or teachers use. The teacher device 128 may have inputs and outputs, which may be communicated through the custom teacher software 112 to other parts of the system. In one embodiment, the teacher device 128 could be an electronic keyboard style piano.

The direct data connection 108 represents a cross-platform sockets connection between the teacher device 128 and the student device 126.

The custom student software 110 is a piece of software that has been developed for students such as the primary student 104 and the other students 106. In some examples, the software may run on iOS, Windows, Mac, Android, xBox, Sony Playstation, Apple TV, FireTV, Sonos, Tivo, or AppleWatch. This custom student software 110 is designed to be cross platform, or to work on any type of computing device, so as any new operating systems enter the marketplace, this custom student software 110 will be published on said new operating systems.

In one embodiment, the custom student software 110 is an educational and entertainment application written to help primary students 104 and other students 106 to improve their skill level at in a particular type of study. Piano, drums, guitar, saxophone, violin, bass guitar, flute, trumpet, and any other instrument, are some examples of types of studies that the custom student software 110 could help the primary student 104 and other students 106 with. The custom student software 110 is not limited to use with musical instruments, in another embodiment, it could be used to teach foreign languages, singing, carpentry, or any other skill to the primary student 104 and other students 106.

The custom teacher software 112 is a piece of software that has been developed for teachers, such as the teacher 102. In some examples, the software may run on iOS, Windows, Mac, Android, xBox, Sony Playstation, Apple TV, FireTV, Sonos, Tivo, or AppleWatch. This custom teacher software 112 is designed to be cross platform, or to work on any type of computing device, so as any new operating systems enter the marketplace, this custom teacher software 112 will be published on said new operating systems.

In one embodiment, the custom student software 110 and custom teacher software 112 may communicate with an Audio and Video Server 114. This server may facilitate real-time audio and video communication between the custom student software 110 and custom teacher software 112. In one embodiment, this allows the primary student 104 and the other students 106 to communicate with the teacher 102 and potentially multiple teachers 102.

In one embodiment, the custom student software 110 and custom teacher software 112 may communicate with a MIDI Data Server 116. This server may facilitate real-time communication between the custom student software 110 and custom teacher software 112. This allows the primary student 104 and the other students 106 to communicate a specific type of information, namely MIDI data, with the teacher 102 and potentially multiple teachers 102. This MIDI data may be real-time or delayed, or some variation thereof. MIDI stands for musical instrument digital interface, and one way it is used is to transfer musical data between devices.

In one embodiment, the custom student software 110 and custom teacher software 112 may communicate with a Content Data Server 118. This server may facilitate real-time communication between the custom student software 110 and custom teacher software 112. This allows the primary student 104 and the other students 106 to communicate a general type of data, commonly referred to as content, with the teacher 102 and potentially multiple teachers 102. This content data may be real-time or delayed, or some variation thereof. The content data which the Content Data Server 118 may send or receive may include data types such as XML, MusicXML, serialized, or de-serialized data communication protocols such as JSON, images such as jpg, png, or gif graphical formats, moving audio and pictures such as video, which might be in the file formats of MP4, MOV, and other formats. Text also may be communicated as metadata to necessary to render the text, for example source code which may generate the text, or rich-text editing languages such as hypertext markup language.

The custom student software 110 and custom teacher software 112 may communicate with an Audio and Video Storage Server 120. In one embodiment, this allows all communication between the primary student 104, and the other students 106, and one or many teachers 102, to be stored for later review. The Audio and Video Storage Server may store material that occurred in real time, for review after the fact.

The custom student software 110 and custom teacher software 112 may communicate with many different servers as a part of its normal operation, as a part of the system. In one embodiment the student software 110 and custom teacher software 112 may communicate with servers that are located on the Internet, called Internet Servers 130. While this embodiment specifies that Internet Servers 130 are used for communication with the custom student software 110 and custom teacher software 112, these servers could also be located on a local area network, virtual private network, or other such networking configuration allowing communication between the custom student software 110, custom teacher software 112, and the Internet Servers 130.

The Relational Database 122 communicates with all other servers, storing all data in a relational manner. For example, the information about the Live Lesson is contained in a relational table storing such information as when the lesson is scheduled to commence, how the lesson was paid for, and other pertinent information. The Live Lesson table also has foreign keys out to the users table, which joins the different types of users to the lesson, primarily students and teachers. The teacher has additional information stored relationally, such as a profile containing information about all manner of techniques and skills the teacher has, including genres they like, their educational background, a biography and other profile information.

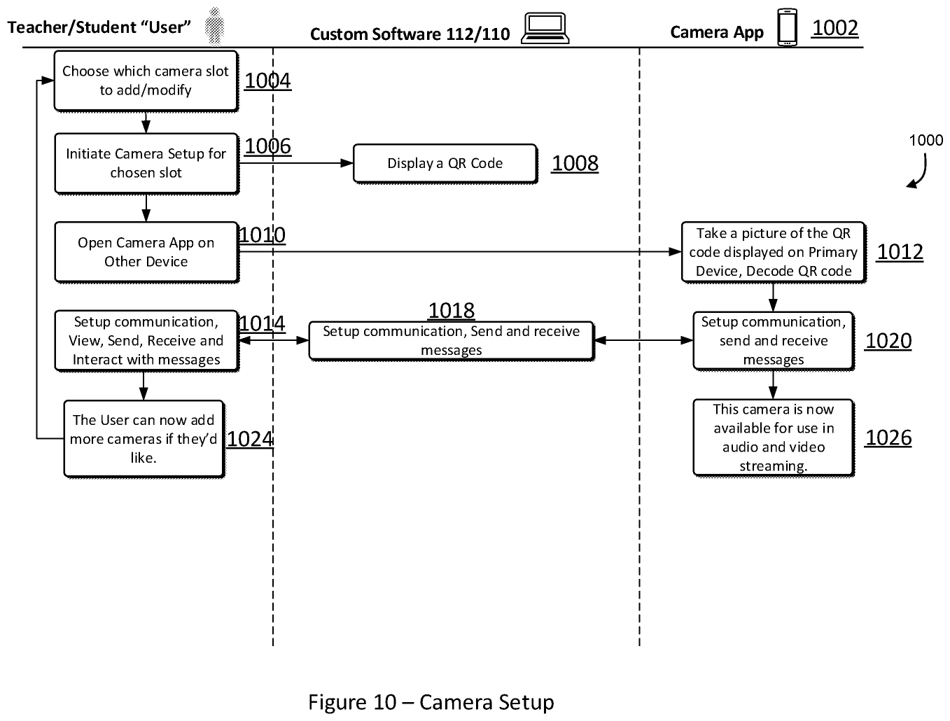

The camera shown in FIG. 1 as 130 is illustrative; there may actually be many cameras per user, as further explained in FIG. 10.

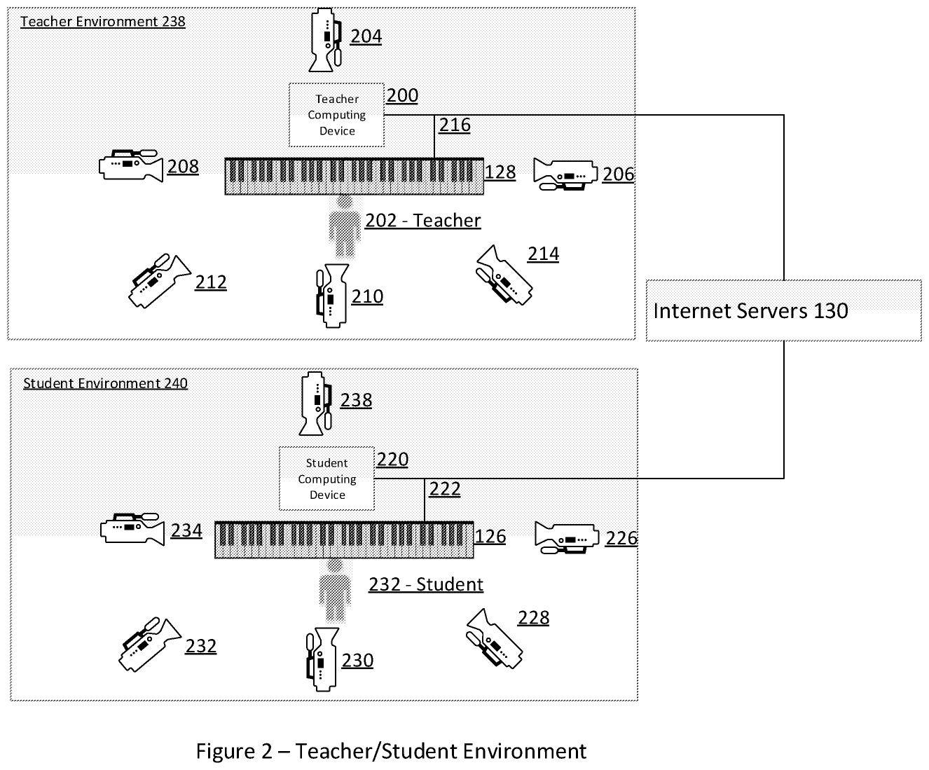

### Description of FIG. 2

This figure is an overview of the teacher and student environment.

The teacher computing device 200 is a computer, tablet, or smart phone. It has a display, input devices like a keyboard, mouse, and/or touchscreen, and a camera and microphone. The microphone and camera may be integrated into the computing device, such as in an iPad, Kindle Fire, or Samsung Galaxy Tab, or the microphone and camera may be external to the device, such as with a Windows PC. The Teacher Computing Device 200 is running the Custom Teacher Software 112.

In one embodiment, the teacher device 128 is shown as a piano style keyboard. This could also be a microphone, guitar, drum-set, trombone, or any other type of device for creating information.

This teacher device 128 may be connected to the Teacher Computing Device 200 via USB, Bluetooth Low Energy, or any other wired or wireless communications protocol, shown in this example as 216. Since the Teacher Device 128 is connected to the Teacher Computing Device 200, which is using the Custom Teacher Software 112, the Teacher Device 128 is able to send and receive messages through the Internet Servers 130 to the Primary Student 104 and the Other Students 106.

As one example, when the Teacher Device 128 is a piano style keyboard, and the teacher 202 presses a key on the piano, the information about which note the teacher played, including the pitch (which note was played), the duration (how long the key was held down for), are sent to the teacher device 128, which are then received by the custom teacher software 112. The custom teacher software 112 sends this information to the internet servers 130, which then sends the information to the custom student software 110, and then sends the information to the primary student device 126 and other student devices 124.

When the teacher presses a key on their Teacher Device 128, which in one option is a piano style keyboard, a NoteOn message is sent through the circuit between the teacher and student(s). This NoteOn message contains a timestamp indicating when the note was pressed. If the key is released quickly, generally within a 200 miliseconds, a subsequent NoteOff message is generated, and sent at the same time as the NoteOn message, also with a timestamp. In this case, the student would receive two messages nearly simultaneously, saying that the teacher depressed a note and released that note (NoteOn and NoteOff, respectively). The duration that the note was held down for can be calculated by the Custom Student Software 110, by comparing the timestamps contained within the NoteOn and NoteOff messages.

If the teacher, for example, were to hold down a note for five seconds, the NoteOn message would be sent, and likely delivered, before the NoteOff message was ever generated. Once the teacher released the key, the NoteOff message would be generated, and sent independently of the NoteOn message.

This process can occur for chords, and keys pressed in rapid succession, as well. It works for any number of notes, held for different lengths of time (or the same amount of time). The NoteOn and NoteOff messages contain all the necessary information to show which key(s) a teacher played, and for how long. It's also bidirectional, so that the student may send the teacher this data, or one teacher may send many students this same data.

In one embodiment, the teacher 202 would press a key on their piano style keyboard, which would generate the NoteOn message, and then the student would receive the note on message, and the sound synthesizer within their 126 primary student device would play the sound that the teacher played. When the teacher stopped playing the note, the NoteOff message would be generated and delivered to the student, and the student would cease to hear the sound coming through their 126 primary device. If the students' primary student device 126 was capable of illuminating their piano-style keyboard keys, the student could also see which key was lit, by decoding the NoteOn and NoteOff messages in a similar fashion. When the teacher 202 presses multiple keys, the same process is repeated for a chord, or multiple keys pressed simultaneously. If there were a way to illuminate other instruments, such a light up fretboard on a guitar, or a light up drum head on a drum set, this process would work the same for any instrument in the student and teacher devices.

The information from the teachers 202 teacher device 128 travels from the teacher device 128 through the teacher computing device 200, using the custom teacher software 112, and the information traveled through the internet servers 130 to the custom student software 110, running on the primary student device 126.

204, 206, 208, 210, 212, and 214 are all teacher cameras that the teacher uses to transmit different views of the teacher and/or his/her environment. Shown are different views that each camera may represent, including top down camera 204, which would be mounted physically above the teacher device 128. The number of cameras used may be a configurable setting in the student and teacher software, which may vary in accordance with the specific hardware that is available to the student and/or teacher. In one embodiment, the teacher device 128 is a piano style keyboard, and the top down camera 204 would be capable of viewing the instructor's hands while playing the teacher device 128.

In one embodiment, each possible teacher camera 204, 206, 208, 210, 212, and 214 comes from either a standalone tablet computer, such as an iPad, Kindle Fire, or Samsung Galaxy Tab, or a smart cellular phone, such as an iPhone or a Samsung Galaxy S7, or desktop or laptop computers. This innovation allows phones, tablets, and computers of all shapes and sizes to act as a video and audio transmission mechanism for the system described herein.

226, 228, 230, 232, 234, and 238 are all student cameras that the student uses to transmit different views of the student and/or his/her environment. Shown are different views that each camera may represent, including top down camera 204, which would be mounted physically above the student device 126. In one embodiment, the student device 126 would be a piano style keyboard, and the top down camera 238 would be capable of viewing the student's hands while playing the teacher device 128.

In one embodiment, each possible student camera 226, 228, 230, 232, 234, and 238 come from either a standalone tablet computer, such as an iPad, Kindle Fire, or Samsung Galaxy Tab, or a smart cellular phone such as an iPhone or a Samsung Galaxy S7, or desktop or laptop computers. This innovation allows phones, tablets, and computers of all shapes and sizes to act as a video and audio transmission mechanism for the system described herein.

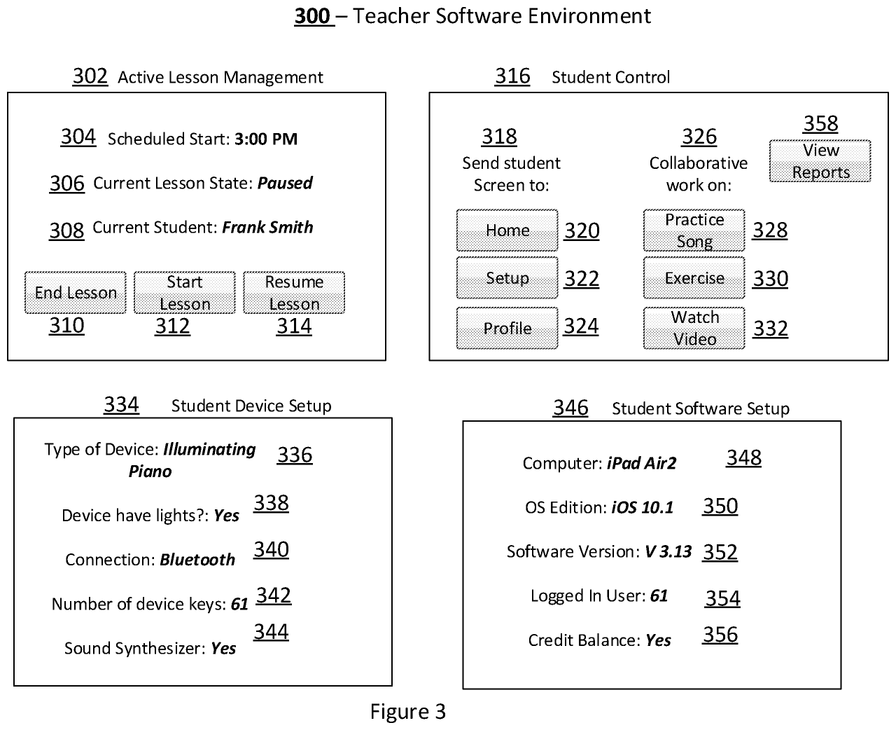

### Description of FIG. 3

FIG. 3 shows an illustrative environment 300 of the teacher software 112. In one embodiment this is used by the teacher 102 to teach the primary student 104 and other students 106. The software depicted by example in 300 is running on the teacher computing device.

The active lesson management 302 portion of the software, in one example, is used to manage a lesson which is either pending (scheduled to start occurring in a short amount of time), currently active and in progress, or has recently completed (the schedule has elapsed).

The schedule start time 304 illustrates when the lesson will begin.

The current lesson state 306 shows whether the lesson is active, pending, completed, cancelled, or any other status.

The current student 308 shows the name of the current student. Other identifying information may be placed in this area, such as their picture, notes about the student, or anything other information about the student that the system has.

The end lesson button 310 is used for terminating a lesson that is in progress.

The start lesson button 312 is used to commence the lesson with the primary student 104 and other students 106.

The resume lesson button 314 is used to resume a lesson that is currently paused.

The student control section 316 is where the teacher 102 can use the custom teacher software 112 to control the custom student software 110 of the primary student 104 and other students 106.

In the send student screen section 318, the teacher 102 could be changing what the student is viewing within the software. Various pages are shown here as buttons, home 320, setup 322, and profile 324. These are areas of the custom student software 110, other buttons or functions could be added here at any other time. The concept is that the teacher 102 could be thousands of miles physically from the primary student 104 and other students 106, but still interacting with their system in a real-time manner to optimize the learning experience. The primary student 104 and other students 106 do not need to spend any time tinkering with the technology or settings, the teacher 102 will take care of it for them.

The collaborative work section 326 in this example is a mechanism for the teacher 102 to give the primary student 104 and other students 106 material to work on in real-time, during a live lesson. The practice song button 328 allows the teacher 102 to give the primary student 104 and optionally other students 106 a musical score to practice. When the teacher 102 presses this button, or similarly causes this practice system to be engaged, the teacher 102 can select a musical score from the content data server 118, or they can upload a new musical score from their teacher computing device 200. The types of content that the teacher 102 can select from the content data server or upload from their computing device 200 may include MusicXML, MIDI data, WAV file, MP3, PDF files, Sibelius files, Finale files, or any other currently existing or yet to be developed file format for communicating musical notation.

In some embodiments, the practice song button 328 that the teacher 102 is selecting for the primary student 104 and optionally other students 106 to practice may not have anything to do with musical notation. If the teacher was teaching carpentry, they might upload or select architectural drawings for the student to work on.

The exercise button 330 in one embodiment allows the teacher 102 to select a predefined, or designed on the fly, exercise or set of exercises for the primary student 104 and optionally other students 106 to work on. These exercises are mini training systems designed to allow the student to rapidly improve their skill.

The watch video button 332 allows the teacher and the student to consume content together, in real time.

The student device setup shown in 334 is describing the student device 126 that the current student is using. 336, 338, 340, 342, 344 would all change based in part on what type of student device 126 is in use. For example, the type of device 336 might be a Gibson Guitar, and many of the options in 340, 342, 344 would change to be more specific to the guitar.

In another embodiment, the student device 126 may not even be a musical instrument, and as such, all the options under 334 would change dramatically.

The settings in 346 are specific to which edition of the custom student software 110 the student is using, along with the student computing device 220.

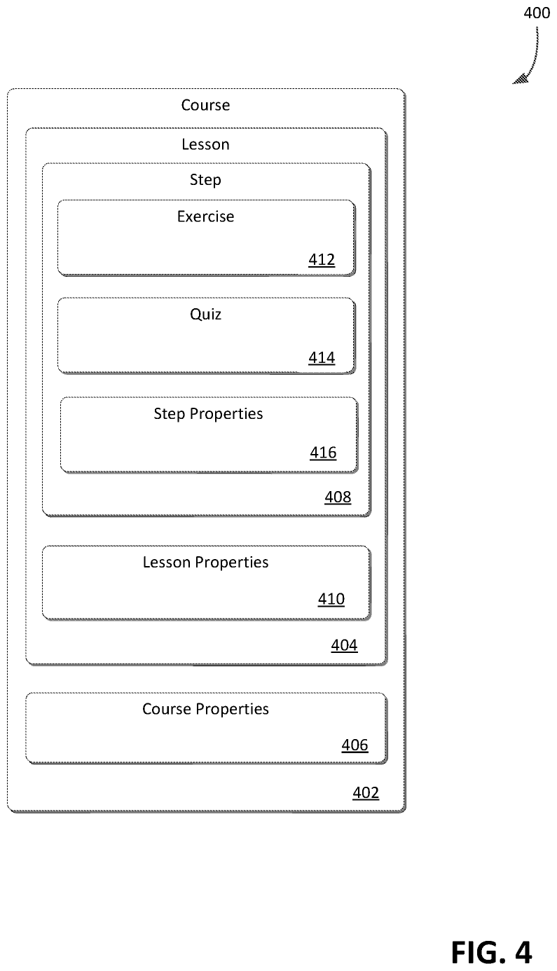

### Description of FIG. 4

FIG. 4 illustrates an example diagram 400 showing the structure of lesson elements for lessons associated with an interactive piano training device, such as an electronic piano keyboard or other musical instrument. In an embodiment, the top level element associated with a lesson is a course 402. A course 402 may have one or more course properties 406 such as a course name, the instructor, one or more course objectives, a link to (e.g., a hyperlink or an identifier associated with) the next course and other such course properties. A course may also contain one or more lessons 404. Each lesson may have one or more lesson properties 410 such as a lesson name, a list of the steps associated with the lesson, one or more musical scores associated with the lesson, a link to the next lesson in the course or other such lesson properties. Each lesson may have one or more steps. A step 408, which may be classified as an exercise 412 or as a quiz 414 based at least in part on one or more step properties 416, is an objective for completing the lesson. Step properties 416 may include, but not be limited to, properties related to the musical score, the playback position, allowable tempo, thresholds for completion, lighting parameters (e.g., handedness and fingering), visibility for the play head, the playback mode and/or other such properties. As may be contemplated, the properties of the steps, the lessons and the courses described herein are illustrative examples and other such properties may be considered as within the scope of the present disclosure.

The course 402 or variations thereof may be stored in any suitable manner, such as in a structured markup language (e.g., using XML, or JSON or other) or in another way, such as in rows of a relational database so that the data of the course 402 is associated with the course and sub-parts of the course such as described above. Thus a device associated with a student and/or teacher can obtain information about courses, such as the courses a user has subscribed to, has available, etc.

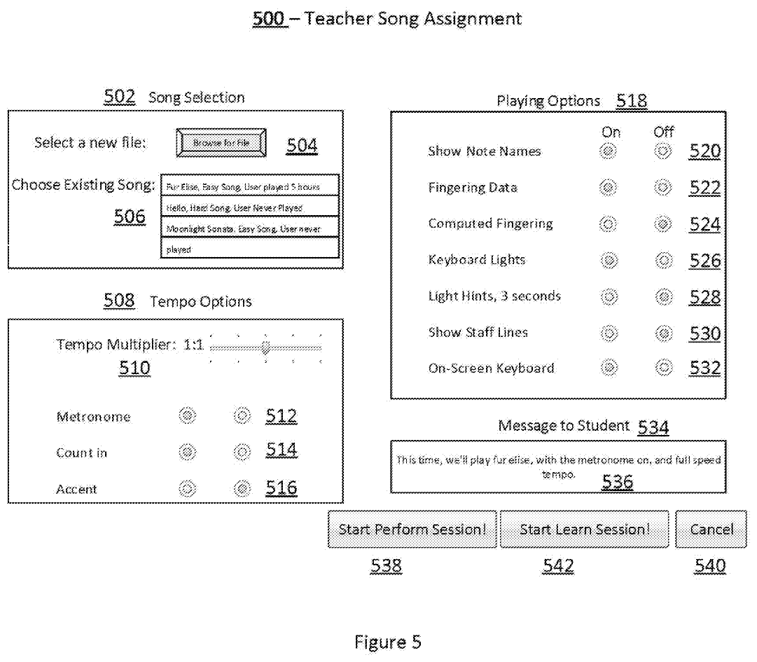

### Description of FIG. 5

Shown here as an illustrative example in the 500 teacher song assignment screen, this may be what appears in the user interface when the teacher 102 presses the practice song button in 328. After 328, in one embodiment, the teacher 102 is presented with a series of options and choices, illustrated in 500. After selecting options, the teacher 102 presses the 538 start practice session button.

The song selection area 502 is where the teacher 102 can either select a new song for upload into the system 504, or choose a song an existing song 506. Existing songs in 506 may have been uploaded by teachers, students, other third parties, or the company. Teachers may also upload their own material, and sell their material directly to students.

Along with the existing songs 506, the system may show other data about that song, including factual data about the song itself, including the artist, genre, title, album cover art, or any other data about the song. Such information may be obtained from metadata obtained from a file encoding the song and/or by querying a web or other service with an identifier of the song to obtain the information. The system may also show along with the existing songs 506 information specific to the primary student 104 or other students 106. In one example, the system may show how much time each student has played each song for, in total, or in the past day, week, month, or year, or any fractional amount thereof.

The teacher 102 can also set certain options regarding the playing experience of the user. The tempo settings 510 allow the teacher to adjust the speed at which the student practices the song and the frequencies at which audible aides (e.g., metronome sounds) for practicing the song are provided. The lower the tempo setting, the slower the song will play. The metronome 512 is a digital version of the traditional metronome device. The count in in 514 allows the user to be counted into the song prior to commencing playing. The common nomenclature for such a count in would be “one two three four” where after “four” the user would commence playing on the next beat. The accent 516 being selected causes the student computing device to play the first beat of a four measure beat in a louder or different fashion than the other beats.

The playing options 518 allow the teacher 102 to specify a variety of options for the students practice session, to maximize the learning potential of the student, given their current skill level, interests, and personal challenges or struggles in learning to play the primary student device 126. The teacher (or system) customizes these settings 518 to enhance the experience of the student.

What actually happens when the teacher selects these options, and sends them to the student, in an embodiment, is a series of messages are generated by the Custom Teacher Software 112, and sent either directly to the student via the direct data connection 108, or via the Internet Servers 130. Each message contains specific information relevant for the options selected. For example, if the teacher sent a song to a student, and wanted the student to play only measures 2-6 of that digital score, and wanted the piece of music to be played at half speed (tempo), then messages containing that information would be generated, and delivered to the student(s). The messages would then contain information that the custom student software 110 needs to update the user interface, to show only measures 2-6 as active, and to programmatically slow down the playing of the song to half speed (50%).

Show Note Names 520 places the names of the note within the note, on the digital score of the custom student software 110. To do this, in one example, the musical score would show the name of the note within the note head itself, although other indicators of the note name, such as the note name next to the note can be used.

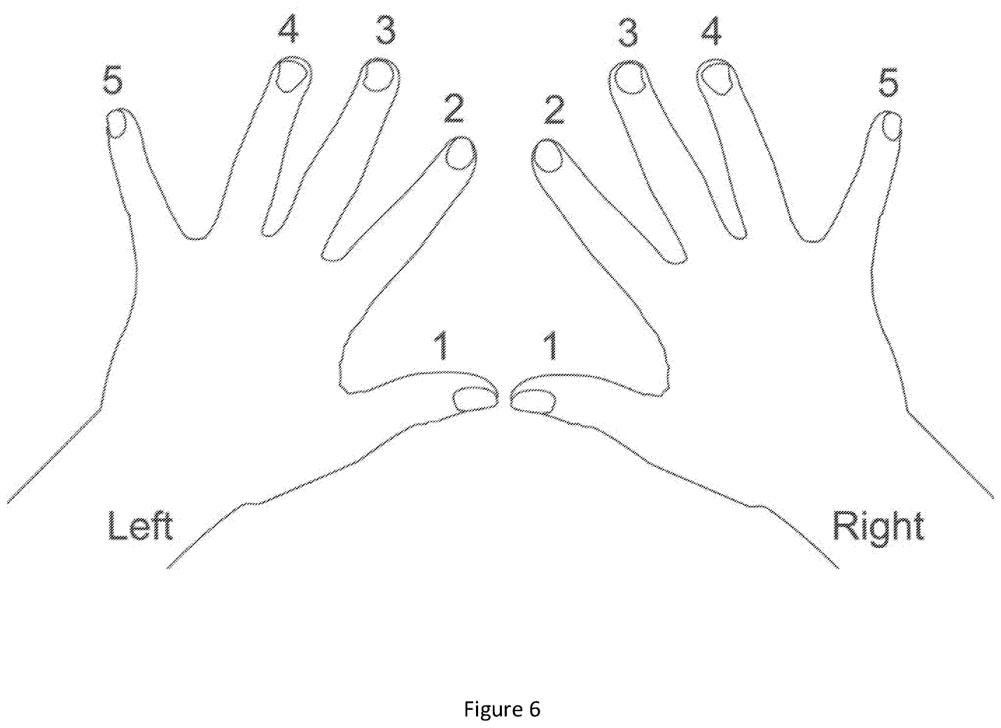

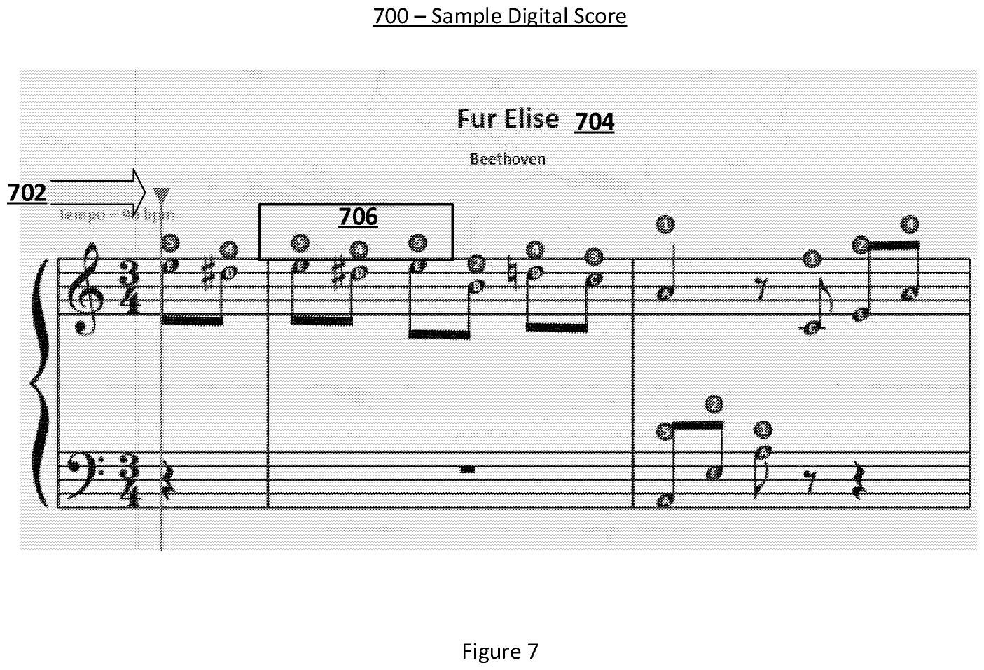

Fingering data 522 in one embodiment allows the teacher 102 to show the primary student 104 which fingers to be used when playing each note. As demonstrated in FIG. 6, in one embodiment, fingering numbers are used to indicate which finger should be used to play which note. FIG. 7 illustrates fingering data as shown in a score in the student software 110. This particular example shows fingering data for piano, but fingering information for other types of primary student devices 126 would represent this information in a different manner. Finger numbers are called out in 706 of FIG. 7 in accordance with a numbering scheme illustrated in FIG. 6, but continue through the rest of the musical score as illustrated in the figure.

Keyboard lights option 526 is a feature that integrates the hardware and software described in this invention. A student's primary device 126 may have an option to light up each key on their device or otherwise indicate how which keys to play (e.g., indicate which keys to press and/or have been pressed by the teacher). If that option is available, this option 526 will allow the teacher 102 to turn that feature on or off.

Light hints 528 allow the teacher 102 to not show the lights, if applicable, on the student's primary device 126, for a configurable number of seconds. For example, if this option is on, the teacher can specify that the lights will not turn on until the primary student has had a few seconds to attempt to find the note for themselves. In some examples, the delay is three seconds, although different durations may be used and, in some examples, the duration before a hint is shown is a configurable setting that can be configured by the teacher and/or by the student using the respective software. As one embodiment is illustrated in 528 it could be a radio button, but another embodiment would allow the teacher to set a configurable number of seconds for the light hints, from 1-100 seconds.

The show staff lines 530 allow the teacher 102 to configure a student's software to show staff lines on the musical score, or not. This can be a tool for identifying notes without the confusing staff lines, or it can be used for other purposes.

The on screen keyboard 532 is used for many purposes. In one embodiment, it is used to indicate when either the teacher or the student has played something. For example, the teacher may tell the student to place each of their five fingers on each of five particular notes. To demonstrate which notes the teacher 102 wants the primary students 104 and other students 106 to place their fingers on, if the teacher 102 plays five notes, one with each finger of their right hand, those five notes would be lit up on the on screen keyboard referenced by 532.

The message to student 534 is text that is delivered to the student before the practice session begins. The example message to student is built automatically based upon the options that the teacher 102 has selected on this page. The teacher 102 can override the text automatically generated in 536, and type whatever they'd like, as well.

When all the options are chosen in the environment 500, the teacher 102 can chose to send the package of options, along with the musical score, to the primary student 104 and other students 106. There are several different embodiments of the type of practice that teacher 102 can instantiate with the primary student 104 and other students 106. Once the options have been chosen, a set of messages are prepared, and delivered to Internet Servers 130, and then eventually to the primary student 104 and other students 106. The messages contain different variables that allow the custom student software 110 to implement the options that the teacher has specified in the environment 500. When the student eventually receives these options, in the form of messages, the server is able to take those variables, and turn them into commands, to set the software options to perform as the teacher has specified.

One embodiment starts “learn” mode, where the custom student software 110 waits for the primary students 104 and other students 106 to play the correct note before advancing to the next note or notes in the musical score. In one embodiment, the line 702 through the notes on the screen is called the play-head, and the play-head is what is supposed to be played next by for the primary students 104 and other students 106. Once the teacher has chosen all options, they can press start learn session 542 to begin this song with the student.

Another embodiment starts “perform” mode, where the custom student software 110 automatically advances the score according to the proper tempo and other settings, regardless of what the primary students 104 and other students 106 play. In one embodiment, the line 702 through the notes on the screen is called the play-head, and the play-head is what is supposed to be played next by for the primary students 104 and other students 106. The play-head moves automatically once commenced through the notes during perform mode. Once the teacher has chosen all options, they can press start learn session 538 to begin this song with the student.

When either start perform session 538 or start lesson session 542 is pushed by the teacher 102, a series of events occur to get the primary students 104 and other students 106 into the proper mode and setup with the proper options.

The first thing that may happen is that if the teacher 102 has selected a new music file for upload 504, that file is submitted through the custom teacher software, to the internet servers 130, to the content data server, and into the relational database. The music file that the teacher selected is now stored on the internet servers 130. The teacher is encouraged, but not required, to upload the content before the lesson commences. This would allow for the student to download the musical score and/or other content before the lesson commences.

The student may also download the file in real time, during the lesson. Once the music file is on the internet servers 130, the student may automatically commence download of that music file, through the custom student software 110, from the internet servers 130, from the content data server 118, from the relational database 122. This would be accomplished by the teacher selecting the file, and sending it to the student, and then the student approving the download of the file.

When the teacher selects a file for the student, there are multiple options for how the Custom Teacher Software 112 and Custom Student Software 110 decide to launch that file on the student's side. The teacher sends a message to the student referencing the compositionID of the material in question, as stored in the relational database 122. If the student already has that compositionID stored within the hard drive or flash memory of their student computing device 220, then the custom student software 110 has all the information required to launch that song. If it does not have that compositionID already stored locally, a call to the Internet Servers 130 is made, requesting that content, and it is downloaded to the hard drive or flash memory of their student computing device 220. Once the download is complete, then the student software 110 may launch the song.

### Description of FIG. 6

This demonstrates an example finger numbering system used for piano instruction. The thumbs are always numbered “1,” and then the pinky fingers are always labeled “5,” with the other digits scaling between “1” and “5.”

### Description of FIG. 7

This illustrates a sample digital score, titled Fur Elise in 704. 702 is the playhead, that may move through the digital score, as the student plays it. As the student plays the score, the playhead 702 move through the musical notes. 706 illustrates how finger numbers from FIG. 6 are noted on a score.

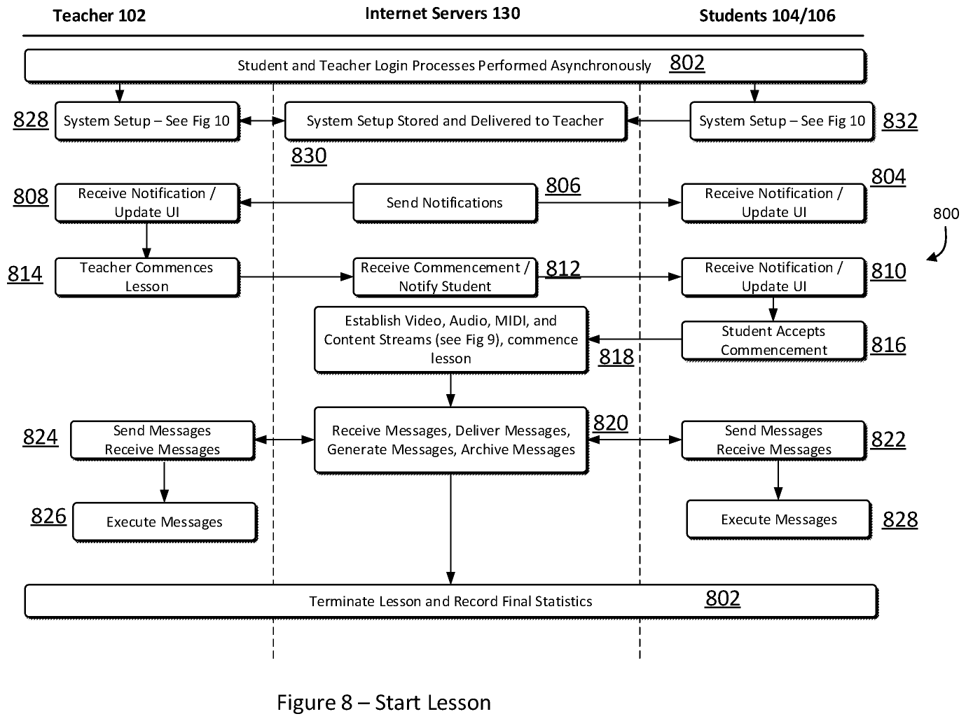

### Description of FIG. 8

The live lesson process, in one embodiment, what might occur is shown in 800. Both the teacher 102 and the primary students 104 and other students 106 log into the custom teacher software 112 by completing an authentication procedure (e.g., by providing a valid username and password or otherwise authenticating) and the custom student software 110, respectively, as shown in 802. This is done by entering previously created or provided credentials into the software.

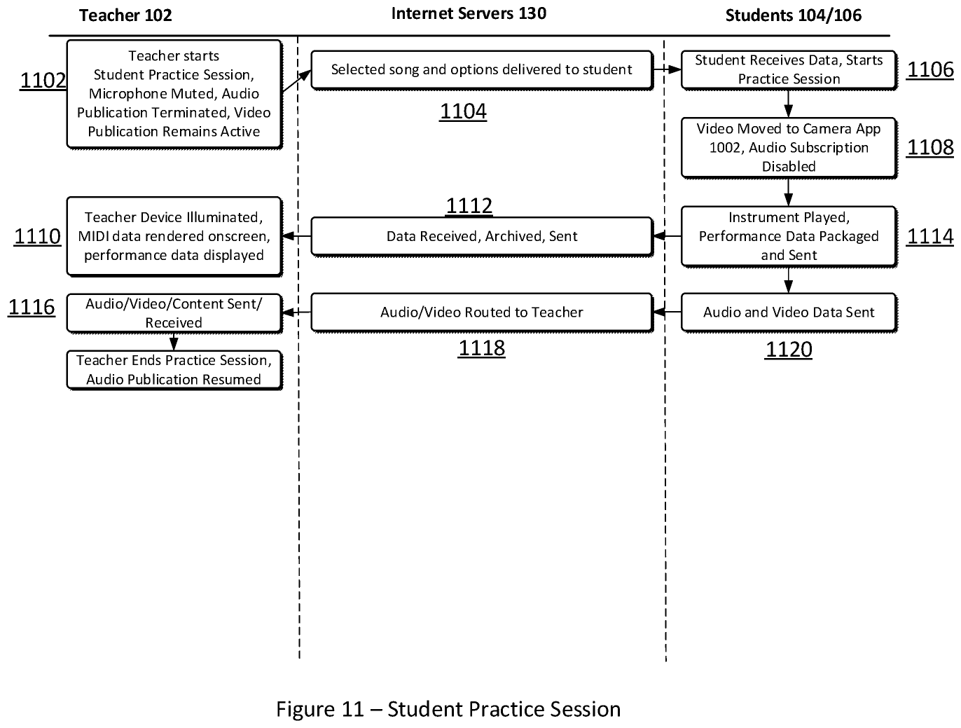

Both the teacher 102 and the primary students 104 and other students 106 perform system setup as outlined in FIG. 11, as indicated by 832 and 828. Once the setup information has been independently submitted to the Internet Servers 130 by whoever is participating in this lesson, which may include one or more teachers and the primary students 104 and other students 106, the system setup for each participant is delivered to the teacher 102 as shown in 830. The system setup may occur only once, with setup settings and other options stored locally on the client or stored remotely on the internet servers 130, or it may occur each time the lesson commences, and not be stored at all.

Once system setup has been completed, each party in the lesson may receive notifications from the internet servers 130, alerting them to the fact that they have an upcoming lesson, and providing the online status for the other party in their lesson. When any party logs into the software, this triggers the system to check to see if they have a lesson in the upcoming 24 hours (or some other duration), and if they do, upon login to the system an online status is set to yes in the relational database 122 for that user.

The primary student 104 (and other students 106) may, as a result of execution of their respective software, be provided a notification in the custom student software 110 telling them that their teacher 102 was online. The teacher 102, similarly, may be provided a notification in the custom teacher software 112 telling them that their primary student 104 was online, and asking the teacher 102 if they would like to start the lesson.

When the teacher 102 has been notified that their student(s) are online and ready to begin the lesson, the user interface of the teacher software updates to enable the teacher to commence the lesson 814. In another embodiment it may be possible for the students to commence the lesson. The teacher 102 requests that the lesson start 814, by clicking, in one embodiment 312. The internet servers 130 receive the request, transmitted from the teacher's device, to commence the lesson, and notify the student that the lesson is about to commence.

The primary student 104 (and optionally other students 106) receive, from an internet server 130, a notification that the lesson will commence, and in one embodiment they may need to approve this before it can commence, and in another embodiment the teacher may commence the lesson, and it would activate, without the primary student 104 (and other students 106) authorizing it. This would be accomplished, in an embodiment, by the teacher sending out a messaging indicating that the lesson is starting immediately, and the students would receive this message, and commence the start of the lesson. This would mean that the teacher would commence the lesson, and the student would be automatically opted into a commenced lesson. This may be particularly relevant for an environment where multiple students are simultaneously receiving a lesson from a single teacher. In that case, it's not practical or needed for multiple students to accept the lesson commencement; the teacher would solely initiate it.

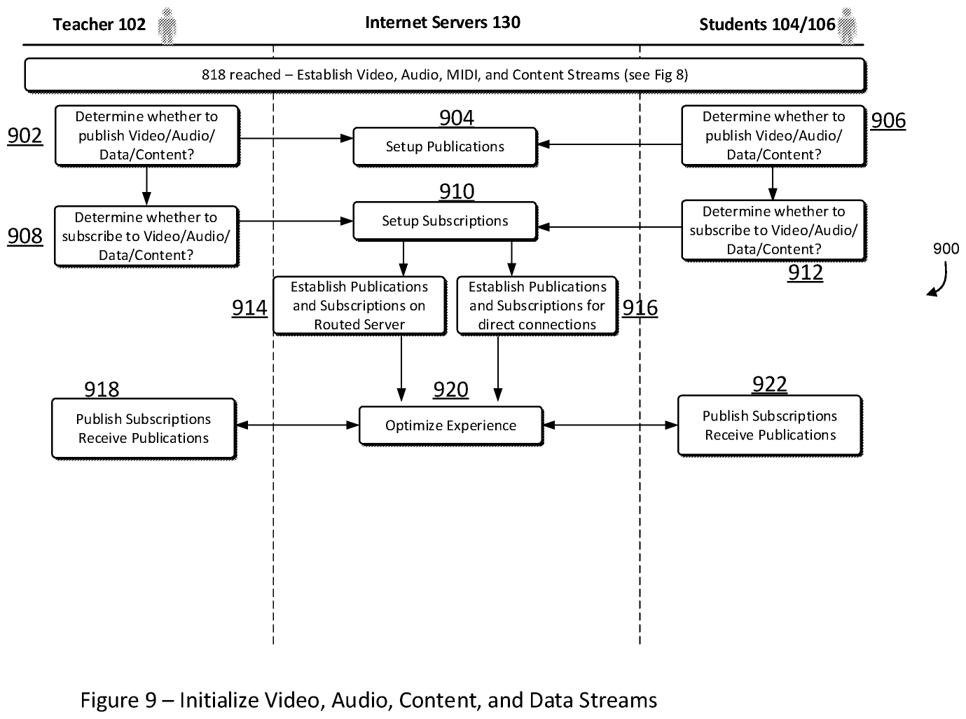

Once the teacher has initiated the start of the lesson, and the primary student 104 (and optionally other students 106) has approved the start of the lesson, the internet servers 130 start the lesson, by establishing data streams of various types. This process is more fully covered in FIG. 9.

The core of the lesson process is one of generating, sending, receiving, and archiving a variety of messages. Once the lesson has commenced and is in an active state, both the teacher 104 and the primary student 104 (and optionally other students 106) are capable of sending, receiving, archiving, and processing (or executing) the different types of messages the system is capable of processing. The types of messages that can be sent may include:

Reporting messages—these are messages which are used to communicate information and status. For example, a teacher may send a message to a student with the title of the message being “Hello” and the body of the message being “Hi student, welcome, we'll start the lesson in just a few minutes.”

App messages—state messages provide current information about the state of the application, such as the current user, is it currently playing music, is a device connected 126, and other facts about the current state of things. Possible other state information that is communicated through these messages include:

IsPlayingMusic—This allows either user to see if the other user(s) are currently playing.

IsMidiConnected—This would allow the teacher to see if the students piano (or other Primary Device 124/126) is currently connected to the software.

IsDownloadingAssets—This would allow any user to see if the other party is currently downloading files or content. For example, if the teacher had sent a song, the teacher could see if that file downloaded using this message.

MasterVolume—Would allow any user to query or send their volume information to the other party. This may be useful if audio issues are happening.

Camera messages—query the other people involved in the lesson about their cameras. Certain camera queries would return details about the camera location, whether it's an overhead camera of a teacher 204, or the right-side camera of the student 226. The capabilities of the camera such as frame rate, color depth, or any other properties of the camera could be queried and reported using this message type. Also which type of device the camera is, whether it is a computer, tablet, or phone, and what operating system it is running.

Camera added or removed—this would communicate to all parties that a new camera had been setup, or an existing camera had been removed.

Setup—this could cause the software to enter the setup mode. For example, a teacher 102, using the custom teacher software 112 could send the primary student 104 a camera setup message, to initiate the setup system on the student's custom student software 110. This would allow the teacher to help the student properly configure their camera(s).

Circuits—A circuit is two sockets, and then a connection between them. A socket is an IP address and a port number. The process of establishing a circuit proceeds in the following manner:

PNStartPingCheck—One user asks the other user if they are available to create a circuit.

PNCompletePingCheck—The user responds that yes, they are available to create a circuit.

PNOpenCircuit—A teacher, for example, attempts to create a circuit with a student, by providing their IP address, and the port number they are using.

PNCompleteCircuit—The student, for example, accepts the circuit request, and provides their IP address, and the port number they are using. The circuit is now open, and data may flow directly between the parties.

PNCloseCircuit—When the circuit is no longer needed, it is closed.

Lesson messages—send typically from the teacher to the student(s).

StartRequest—used to begin a lesson.

StartReply—used to accept the beginning of a lesson.

Pause—put the lesson into a paused state, in case someone needs a moment.

Resume—a paused lesson can be resumed.

End—terminates the lesson.

Communication messages—may flow in any direction.

Postcard—A postcard is a type of message delivered from one party to another (or to many others). It has a subject, a message, and may use predefined graphics, or the user may attach their own graphic to it.

Text—used to communicate text between parties.

url—used to send a web address to the other party. When sent, content may be viewed in the app, or opened in a separate browser window.

Piano Messages

Connection—what type of piano or other device (124, 126, 128) is currently connected. The manufacturer of that product, does it offer illumination features, and if it does, what channel is light communication sent through, does it have an onboard synthesizer, and what is the size of the instrument.

Sheet Reader Messages—one of the most important aspects of this invention is the ability of the teacher 102 to control the software of the primary student 104 and other students 106. Under some embodiments, the students may also control the teacher's software. One embodiment of the sheet reader found in the custom student software 110 and the custom teacher software 112 is shown in FIG. 7. It's a musical score, with notes appearing on the score.

Command messages—it's possible to command the sheet reader 700 to perform certain functions. These are some functions that could be remotely or locally caused to happen through a message.

Command Listen mode—in the custom student software 110 and the custom teacher software 112 is where the software automatically advances the play-head 702 through the score, playing each note through either the hardware or software synthesizer of any of the participants devices (124, 126, and/or 128), appropriate to the tempo specified in 510, or through the software based sound synthesizer in the custom student software 110 and the custom teacher software 112. In one embodiment, a teacher 102 could launch a specific song in listen mode, so that the student(s) could hear how a piece of music was supposed to be played, and see the play-head 702 advancing through the score as the notes were played in the proper timing, attack, and duration.

Command Learn Mode—One embodiment starts “learn” mode, where the custom student software 110 waits for the primary students 104 and other students 106 to play the correct note before advancing to the next note or notes in the musical score. In one embodiment, the line 702 through the notes on the screen is called the play-head, and the play-head is what is supposed to be played next by for the primary students 104 and other students 106.

Start Practice Session—a practice session is where the teacher 102 uses a screen similar to 500 in FIG. 5 to launch a session for the primary students 104 and other students 106. For example, the teacher 102 fills out all of the options previously described on 500, and then starts the practice session.

### Description of FIG. 9

This illustration demonstrates one possible setup process for establishing a video, audio, and data link between the teacher(s) 102 and primary student 104 and other students 106. In 902 and 906, the student(s) and teacher(s) decide whether to publish any streams. Publishing might mean sending data of some type (e.g., a stream of video data and/or audio data) to subscribers. This might be accomplished by checking a box or other configurations, to indicate whether they want to publish audio, video, MIDI, or content streams. Other streams such as voice or any instrument may be supported in the future. The preferences of each user on stream publication are submitted to the internet servers 130 in 904.

In a similar operation, student(s) and teacher(s) decide whether to subscribe to any streams in 908 and 912. Subscribing might mean receiving data of some type (e.g., a video and/or audio stream) from publishers. This might be accomplished by checking a box or other configurations, to indicate whether they want to subscribe to audio, video, MIDI, or content streams. Other streams such as voice or any instrument may be supported in the future. The preferences of each user on stream subscription are submitted to the internet servers 130 in 910.

In 914, the publications and subscriptions are setup for a routed server experience. This means that the internet servers 130 will act as an intermediary for published and subscribed content. In this example, the circuit described in 108 may be routed through other servers. This just means that the circuit is not directly between the two users, but it routed through intermediary servers, usually to boost performance, or for other reasons.

In 916, the publications and subscriptions are setup for a direct experience. This means that the student(s) and teacher(s) will connect directly for communication of sending of publication and receiving of subscriptions. This is more fully described in the Circuit message below.

In 920, the software continually (e.g., periodically) optimizes the experience. The settings that may be adjusted includes whether certain subscriptions and publications are sent over routed or direct connections. It may also include raising or lowering the quality of audio and/or video subscriptions and publications. Optimizing the experience may include changing between routed and direct connections, as well as detecting buffering, instructing the server to lower the resolution, then repeat if detecting more buffering.

### Description of FIG. 10

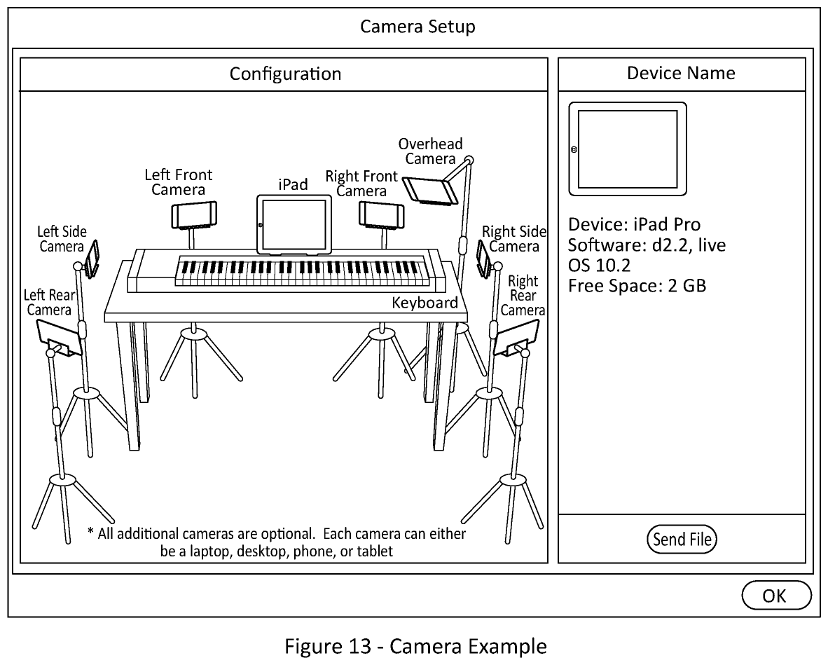

This demonstrates one embodiment for allowing multiple cameras to be used in an online environment 1000. In this example, users can configure multiple devices to act as cameras for the custom software 110 and 112. So in this example, a student 104 could use the setup process outlined in 1000 to configure multiple cameras for use in the application. A sample screen that may be used to setup each camera is shown in FIG. 13.

In 1002 we are showing that there are two different pieces of software in this solution. The teacher/student software that we've discussed in 110 and 112 is separate from the camera app 1002. The camera app 1002 is a separate application, but in another embodiment it may be a part of either or both the teacher software 110 and/or the student software 112.

In 1004, the user (which is a primary student 104, another student 106, or a teacher or teachers 102), in one embodiment, chooses which slot for the camera they want to edit include. In FIG. 13, many different camera locations are illustrated, which may include cameras above, behind, in-front of, and to either the right or left side of the user, or any combination thereof. For example, there might be a rear-right camera, front-left camera, overhead-right camera, or any other possible placement or configuration of the cameras. Once the user has chosen which slot they want to add or modify, setup is launched for the selected camera location 1006, and a QR code is displayed on the software of 112/110.

In 1010 the user opens the camera app 1002 on another device, and then in 1012, they take a picture of the QR code that was displayed in 1008. The Camera App 1002 decodes the information that was rendered within the QR code on 1008, and initiates an internal setup process as shown by 1020. 1020 decodes the information contained in the QR code, which are tokens and keys used to associate the camera software 1002 with the custom software 112/110. The tokens contain a session id and a unique token, relating to the user and their additional cameras. The tokens are used to connect the Camera App 1002 to the Custom Student Software 110. Once the setup of 1018 is complete, the user is now able to use the specific camera app 1002 in the specified slot chosen in 1004. In one embodiment, the user has chosen for example “rear left” camera to be associated with a particular phone, tablet, computer, or other computing or camera device, with their custom software.

The primary student 104, other student 106, or a teacher or teachers 102 are able to configure multiple cameras per user. In 1024 it is shown that the user may configure as many cameras as they like for the implementation.

### Description of FIG. 11

In FIG. 11, this outlines the process used when the student plays a piece of music, which has been assigned to them by the teacher. In 1102, the teacher presses the 538 start perform lesson or 542 start learn session buttons to initiate a practice session with a student. Other types of practice will be eventually allowed, including games, quizzes, and other interactive experiences targeted at improving the student's skill in real time. What happens in 1102 is a series of events designed to optimize the experience for the student. This may include muting the teacher's microphone, so that the student playing doesn't come back to the student, through the instructor's video chat, with a delay. This may cause an echo for the student, of them playing, and then them playing with a slight delay, making it difficult to concentrate.

One solution we may deploy is that the teacher's microphone is muted during the performance.

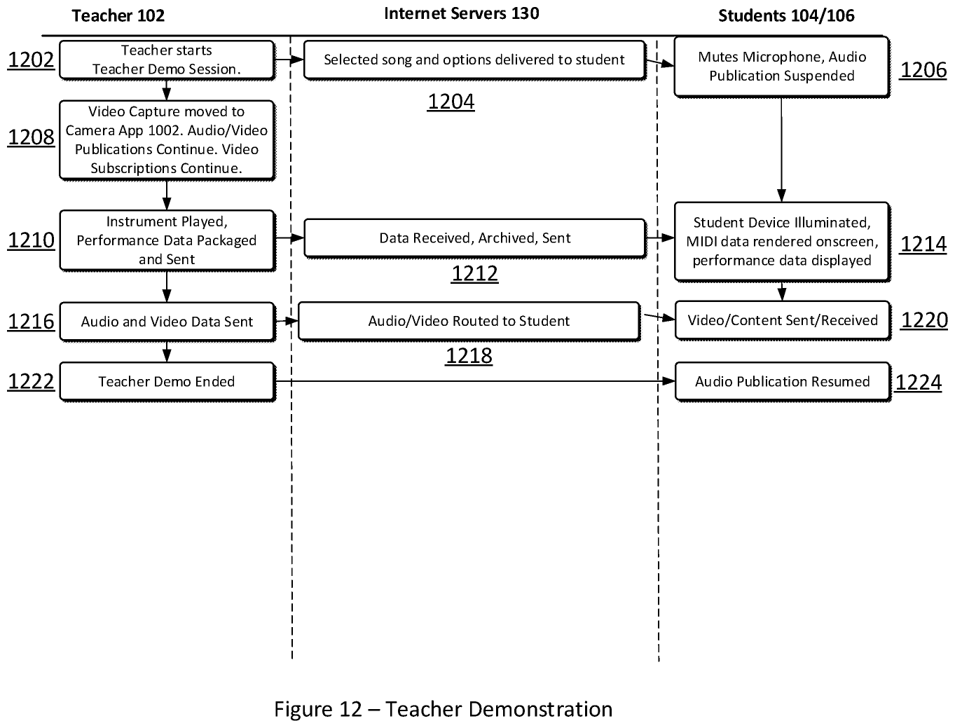

### Description of FIG. 12

In this figure, we demonstrate the reverse of FIG. 11, where the teacher is now demonstrating something, and the student is watching the performance.

### Description of FIG. 13

Here we demonstrate what a setup screen might look like for a multi-camera environment.

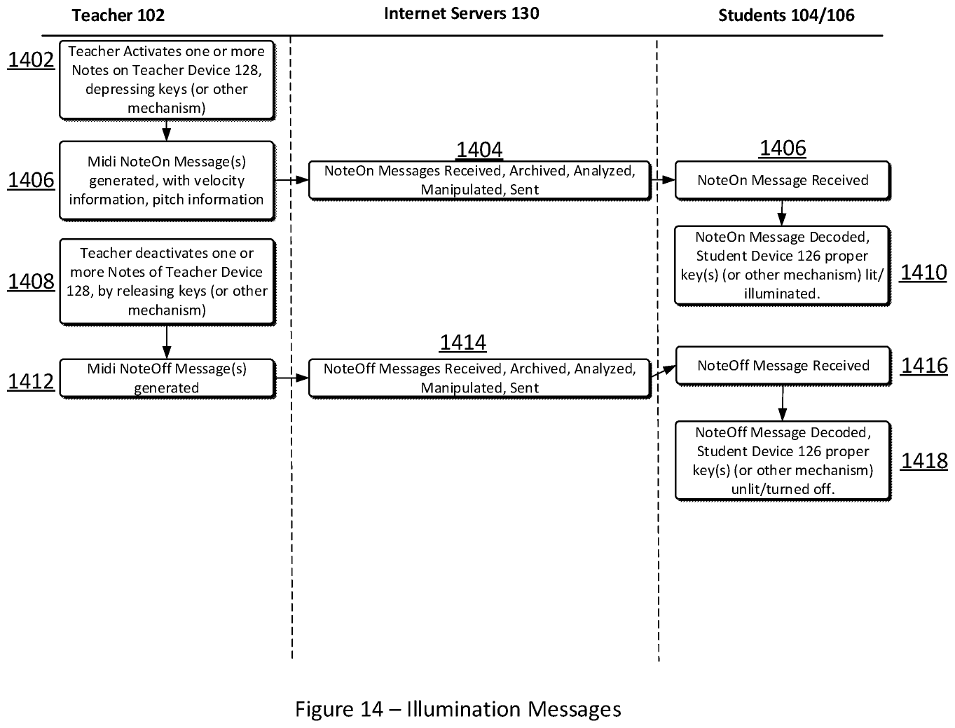

### Description of FIG. 14

FIG. 14 demonstrates the messages being sent from the teacher 102, and the teacher device 128, to the students 104/106, and the student's devices 124/126, with the help of the internet servers 130. One embodiment of this allows a teacher to play their piano style keyboard 128, and if the student 104/106 had a piano style keyboard with lights in the keys, the student's keys will light up when the teacher plays. This is useful because the student can see which keys the teacher is playing. This can happen the other way, too, where the student 104/106 plays their keys on their device 124/126, and the teacher's device 128 lights up when the students 104/106 play.

When the teacher 102 presses a key, a NoteOn MIDI message is generated, specifying which note or notes was depressed, at which MIDI pitch, as well as the velocity that was used to generate the note. The velocity determines the level, or volume, or force, with which the key was played. If there other instruments being used, such as a guitar or a drum set, a similar NoteOn message will be generated, though the mechanism used to capture the sound may be different.

One such implementation might be a microphone listing to the audio generated from the instrument, and then the Custom Student Software would analyze the frequency of the note(s) that was(were) played, and determine which MIDI pitch was played based upon frequency analysis of the sound that was produced. This would allow the software to listen to the notes being played, and convert them into digital information, containing the note(s) played, which pitch was played, and the velocity/force/volume level of the note(s) played.

Another implementation, for other instruments, would include physically connecting the Primary Student Device 126 to the Student Computing device 220. The connection methods could include any type of a cable, such as a USB cable, or a ¼″ or ⅛″ audio cable, a serial cable, or any current cable connecting. In this example, the velocity of the key may be determined based on signals from one or more sensors that measure key displacement velocity (e.g., by measuring the timing between initial movement of the key until the key stops moving, such as by being held in a depressed position or by being released and allowed to return to a resting, unplayed, position).

Another implementation, for other instructions, would include a wireless connection between the Primary Student Device 126 to the Student Computing device 220. The methods could include Bluetooth, WiFi, or any other relevant wireless communication method. In this implementation, one or more sensors may be used to determine the velocity as described above.

If the teacher's device 128 and the student's devices 124/126 are not piano style keyboards, but are other instruments or devices, this system will be adapted. If there were a way to illuminate other instruments, such a light up fretboard on a guitar, or a light up drum head on a drum set, this process would work the same for any instrument in the student and teacher devices. One embodiment of the invention pertains to real-time transmission of musical data, and then subsequently notifying the user through their device of what the other party did.

The process of communication begins with the teacher playing notes on their device 128, as shown in 1402. The information is then packaged into a message in 1406, and routed through the internet servers 1404, to the student in 1406. In 1406, the teachers primary device 124 helps the custom teacher software determine the volume (which is correlated with the velocity and which may be based at least in part on a local volume setting) of the note played, that is, how loud it is. When the teacher 102 presses a note, the primary device has internal circuitry to calculate how quickly two different internal switches are hit. The length of time measured between the closing of switch #1 and switch #2 demonstrates how much force the teacher 102 used to depress the note. The force information is translated into velocity by looking at the difference in time between the two switches closing. If the teacher 102 presses softly, the switches will close slower, and if they press with more force, the switches will close quickly. This information is passed to the custom teacher software 112, which then determines how loudly the note was played based upon this information. This is shared as a part of the MIDI NoteOn message. The same process is true for the student communicating information back to the teacher.

In 1408 the teacher releases the key, generating a NoteOff message 1412, which is then transmitted through the servers in 1414, and delivered to the student 1416. When the student(s) receive the NoteOff message, the lights on their device are turned off.

The whole process may also illuminate a virtual keyboard (or other instrument) on the screen of the student or teacher software, in addition to (or in place of) illuminating a note(s) on their device.

There is also the issue of latency, which the present invention solves. When the teacher plays a note, and a NoteOn message is generated, there is an indeterminate amount of time until the student actually receives that NoteOn message, due to Internet latency. The present invention solves this problem by timestamping each NoteOn and NoteOff message sent between students and teachers, and vice versa. When the teacher 102 plays a note on their primary device 128, and then releases the note, the NoteOn message contains a timestamp, and the NoteOff message contains a timestamp. When the student 104/106 receives these messages, they may come in out of order. The custom student software will arrange the notes in the order they were played, and with the proper amount of time between notes, so that the students while there may be latency between the time the teacher plays a note, and the student receives it, when the student receives a series of NoteOn and NoteOff messages, the Custom Student Software will play all messages in the proper order, and with the proper spacing between notes, and all notes will be at the volume level as desired by the teacher. If the teacher played chords (notes played nearly simultaneously), all notes will be played as chords when the student hears them. The system automatically synchronizes the playback of notes, based upon what actually occurred when the teacher played them.

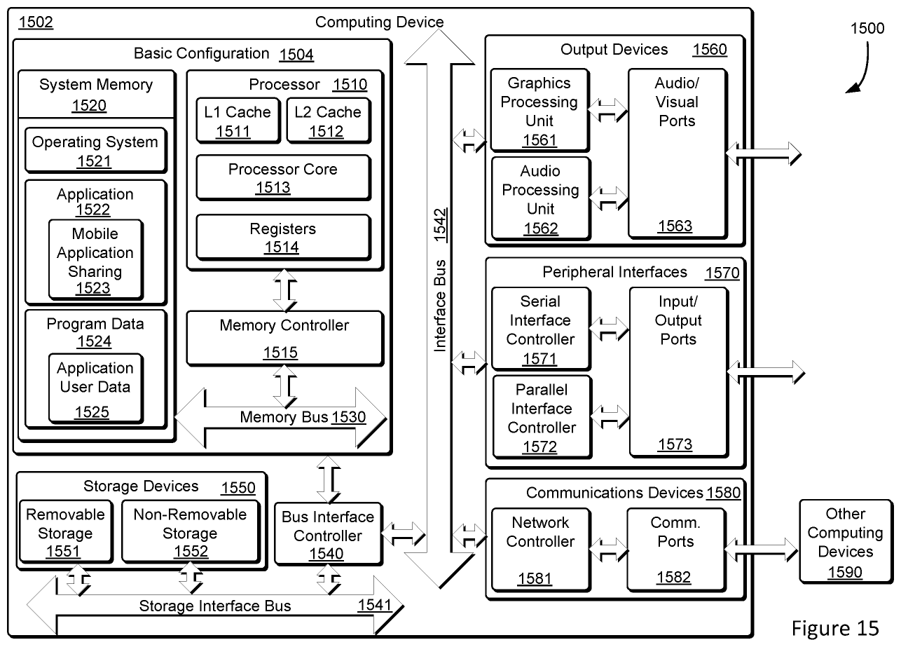

### Description of FIG. 15

FIG. 15 illustrates an example 1500 that may be used to implement one or more devices 1502 in accordance with various embodiments, in accordance with the present disclosure. In a basic configuration 1504, a computing device 1502 may include one or more processors 1510 and may include memory such as system memory 1520. A memory bus 1530 may be used for communicating between a processor 1510 of the computing device 1502 and the system memory 1520. The computing device 1502 may include any appropriate device operable to send and/or receive requests, messages or other information over an appropriate network and may, in some embodiments, convey information back to a user of the computing device in response to such requests. Examples of such computing devices include personal computers, cell phones, handheld messaging devices, laptop computers, tablet computers, set-top boxes, personal data assistants, mobile devices, wearable devices, embedded computer systems, electronic book readers, server computer systems, application specific client devices, and the like. The network may include any appropriate network, including an intranet, the Internet, a cellular network, a local area network, a satellite network, or any other such network and/or combination thereof. Communication over the network can be enabled by wired or wireless connections and combinations thereof.

The information may include, but is not limited to, text, graphics, audio, video, and/or other data usable to be provided to the user. The information may be conveyed in the form of HyperText Markup Language (“HTML”), Extensible Markup Language (“XML”), JavaScript, Cascading Style Sheets (“CSS”), or some other such client-side structured language or in other formats. Content may be processed by the computing device 1502 to provide the content to the user of the computing device 1502 in one or more forms including, but not limited to, forms that are perceptible to the user audibly, visually, and/or through other senses including touch, taste, and/or smell. Requests and responses sent over the network may be handled by a server using PHP: Hypertext Preprocessor (“PHP”), Python, Ruby, Perl, Java, HTML, XML, or another appropriate server-side structured language. It should be understood that operations described herein as being performed by a single device may, unless otherwise clear from context, be performed collectively by multiple devices (e.g., multiple servers, each with a module configured with executable instructions to cause each respective server to perform respective operations).

In some embodiments, the processor 1510 may be of a type including but not limited to a microprocessor, a microcontroller, a digital signal processor (DSP), or any combination thereof. A processor 1510 may include one more levels of caching, such as a level one (L1) cache 1511 and a level two (L2) cache 1512. A processor may also include a processor core 1513, and registers 1514. The processor core 1513 may include, for example, an arithmetic logic unit (ALU), a floating point unit (FPU), a digital signal processing core (DSP Core), a graphics processing unit (GPU), or a combination of these and/or other such processing units. Note that the term “processor” may encompass multiple processor units (e.g., cores) working in concert. A memory controller 1515 may also be used with the processor 1510 to control the memory such as the system memory 1520. In some implementations the memory controller 1515 may be an internal part of the processor 1510.

In some embodiments, the system memory 1520 may be of any type including but not limited to volatile memory (such as RAM), non-volatile memory (such as ROM, flash memory, etc.) or any combination thereof. System memory 1520 may contain an operating system 1521, one or more applications 1522, and program data 1524 associated with such applications 1522. An application 1522 may include a component 1523 configured for sharing applications between mobile devices in a peer-to-peer environment, in accordance with the present disclosure. The program Data 1524 may include applicant or organizational data 1525 as described herein. In some embodiments, application 1522 can be arranged to operate with program data 1524 on an operating system 1521 such that operation of a system may be facilitated on general purpose computer systems.

A computing device 1502 can have additional features or functionality, and additional interfaces to facilitate communications between the basic configuration 1504 and any required devices and interfaces. For example, a bus/interface controller 1540 can be used to facilitate communications between the basic configuration 1504 and one or more data storage devices 1550 via a storage interface bus 1541. The data storage devices 1550 can be removable storage devices 1551, non-removable storage devices 1552, or a combination thereof. Examples of removable storage and non-removable storage devices include magnetic disk devices such as flexible disk drives and hard-disk drives (HOD), optical disk drives such as compact disk (CD) drives or digital versatile disk (DVD) drives, solid state drives (SSD), and tape drives and/or other such storage devices. Examples of computer storage media may include volatile and nonvolatile, removable and non-removable media implemented in any method or technology for storage of information, such as computer readable instructions, data structures, program modules, or other data.

System memory 1520, removable storage device 1551 and non-removable storage device 1552 are all examples of computer storage media. Computer storage media (or computer-readable medium) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1502. Any such computer storage media can be part of device 1502.

Computing device 1502 may also include an interface bus 1542 for facilitating communication from various interface devices (e.g., output interfaces, peripheral interfaces, and communication interfaces) to the basic configuration 1504 via the bus/interface controller 1540. Example output devices 1560 include a graphics processing unit 1561 and an audio processing unit 1562, which can be configured to communicate to various external devices such as a display or speakers via one or more audio/visual ports 1515. Example peripheral interfaces 1570 include a serial interface controller 1571 or a parallel interface controller 1572, which can be configured to communicate with external devices such as input devices (e.g., keyboard, mouse, pen, voice input device, touch input device, etc.) or other peripheral devices (e.g., printer, scanner, etc.) via one or more I/O ports 1573.

An example communication device 1580 may include a network controller 1581, which can be arranged to facilitate communications with one or more other computing devices 1590 over a network communication via one or more communication ports 1582. Communication ports 1582 may further include components configured to communicate over a near-area network. Examples of such communication ports 1582 may utilize at least one network for supporting communications using any of a variety of protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), and Common Internet File System (“CIFS”). The network can be, for example, a local area network, a wide-area network, a virtual private network, the Internet, an intranet, an extranet, a public switched telephone network, an infrared network, a wireless network, a satellite network and any combination thereof.

A computing device 1502 may be implemented as a computer such as a laptop computer, a personal computer, a workstation, a server, or some other such computer device. A computing device 1502 may also be implemented as a portable (or mobile) computer such as a cell phone, a personal data assistant (PDA), a personal media player device, a wireless web-watch device, a personal headset device, an application specific device, or some other such device. A computing device may also be implemented as a combination of computer and/or portable devices including, but not limited to, the devices described herein. A computing device 1502 may include an operating system that may provide executable program instructions for the general administration and operation of that device and may include a computer-readable storage medium (e.g., a hard disk, random access memory, read only memory, etc.) storing instructions that, when executed by a processor of the device, allow the device to perform its intended functions.

The computing device 1502 illustrated in the example computer system 1500 may be part of a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 15. Thus, the depiction of the system illustrated in FIG. 15 should be taken as being illustrative in nature and not limiting to the scope of the disclosure. The various embodiments may also be implemented in a wide variety of operating environments, which in some cases can include one or more computers and/or computing devices that may be used to operate any number of applications. Such devices may include any of a number of general purpose personal computers, such as desktop, laptop, or tablet computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, application specific devices, and other devices capable of communicating via a network. These devices also can include virtual devices such as virtual machines and other such virtual devices capable of communicating via a network.

Embodiments of the disclosure can be described in view of the following clauses:

1. A system, comprising:

one or more processors; and

memory storing instructions executable by the one or more processors to causes the system to:

associate together streams of data from at least three devices separated by a network, the at least three devices comprising a first device of a first user, a second device of the first user, and a third device of a second user, wherein

association of the streams of data together enables the first device to receive data from the third device and the third device to receive data from the first device and the second device, wherein the data from the first device and the second device indicate playing of a first musical instrument by the first user and the data from the third device indicates playing of a second musical instrument by the second user;

update a first user interface of the first device according to an event that occurred on the third device; and

update a second user interface of the third device according to an event that occurred on the third device.

2. The system of clause 1, wherein at least one of the streams of data comprises messages generated as a result of activation of switches of the first musical instrument or second musical instrument.
3. The system of claim 1 or 2, wherein a first stream of the streams comprises messages generated as a result of activation of switches of the first musical instrument and a second stream of the streams comprises messages generated as a result of activation of switches of the second musical instrument.
4. The system of any of clauses 1-3, wherein the streams of data comprise messages that cause the first musical instrument to indicate notes played by the second musical instrument.
5. The system of any of clauses 1-4, wherein the streams of data comprise messages that cause the second musical instrument to indicate notes played by the first musical instrument.
6. The system of any of clauses 1-5, wherein the first musical instrument and second musical instrument comprise electronic piano keyboards.
7. The system of any of clauses 1-6, wherein the instructions are further executable to cause the first device to display a code to be captured by the second device to enable a data stream of the first device to be associated with a data stream of the first device.
8. The system of any of clauses 1-7, wherein the first user interface of the first device is usable to configure parameters for a lesson to cause the second user interface to update in accordance with parameters set on the first user interface.
9. The system of any of clauses 1-8, wherein the second user interface of the second device enables selection from multiple video streams for display.
10. The system of any of clauses 1-9, wherein the instructions are further executable to cause the system to associate a fourth data stream from a fourth device associated with a third user with the first data stream, second data stream, and third data stream such that one of the first device or third device receives the fourth data stream.
11. The system of any of clauses 1-10, wherein at least one of the data streams comprises fingering data that indicates finger positions for playing the first musical instrument or the second musical instrument.
a12. The system of any of clauses 1-11, wherein at least one of the data streams comprises light hints data that causes the first musical instrument or the second musical instrument to indicate how to play the first musical instrument or the second musical instrument according to a musical score.
13. The system of any of clauses 1-12, wherein the instructions are further executable to transmit a notification to both the first device and the third device to enable the first device and third device to receive data streams from each other.
14. The system of any of clauses 1-13, wherein the data streams comprise messages that cause keyboard keys to illuminate.
15. The system of any of clauses 1-14, wherein the data streams comprise messages that indicate levels of force applied to keys of the first musical instrument and/or second musical instrument.

Storage media and computer readable media for containing code, or portions of code, can include any appropriate media known or used in the art, including storage media and communication media, such as, but not limited to, volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory, or other memory technology, Compact Disc Read-Only Memory (“CD-ROM”), digital versatile disk (DVD), or other optical storage, magnetic cassettes, magnetic tape, magnetic disk storage, or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The various embodiments further can be implemented in a wide variety of operating environments, which in some cases can include one or more user computers, computing devices, or processing devices which can be used to operate any of a number of applications. User or client devices can include any of a number of general purpose personal computers, such as desktop, laptop, or tablet computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network. These devices also can include virtual devices such as virtual machines, hypervisors, and other virtual devices capable of communicating via a network.

Various embodiments of the present disclosure utilize at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, a satellite network, and any combination thereof.

In embodiments utilizing a web server, the web server can run any of a variety of server or mid-tier applications, including Hypertext Transfer Protocol (“HTTP”) servers, FTP servers, Common Gateway Interface (“CGI”) servers, data servers, Java servers, Apache servers, and business application servers. The server(s) also may be capable of executing programs or scripts in response to requests from user devices, such as by executing one or more web applications that may be implemented as one or more scripts or programs written in any programming language, such as Java®, C, C#, or C++, or any scripting language, such as Ruby, PHP, Perl, Python, or TCL, as well as combinations thereof. The server(s) may also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. Database servers may include table-based servers, document-based servers, unstructured servers, relational servers, non-relational servers, or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU” or “processor”), at least one input device (e.g., a mouse, keyboard, controller, touch screen, or keypad), and at least one output device (e.g., a display device, printer, or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs, such as a client application or web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

What is claimed is:

1. A system, comprising:
one or more processors; and
memory storing instructions executable by the one or more processors to causes the system to:
associate together streams of data from at least three devices separated by a network, the at least three devices comprising a first device of a first user, a second device of the first user, and a third device of a second user, wherein
association of the streams of data together enables the first device to receive data from the third device and the third device to receive data from the first device and the second device, wherein the data from the first device and the second device indicate playing of a first musical instrument by the first user and the data from the third device indicates playing of a second musical instrument by the second user;
update a first user interface of the first device according to an event that occurred on the third device; and
update a second user interface of the third device according to an event that occurred on the third device.

2. The system of claim 1, wherein at least one of the streams of data comprises messages generated as a result of activation of switches of the first musical instrument or second musical instrument.

3. The system of claim 1, wherein a first stream of the streams comprises messages generated as a result of activation of switches of the first musical instrument and a second stream of the streams comprises messages generated as a result of activation of switches of the second musical instrument.

4. The system of claim 1, wherein the streams of data comprise messages that cause the first musical instrument to indicate notes played by the second musical instrument.

5. The system of claim 1, wherein the streams of data comprise messages that cause the second musical instrument to indicate notes played by the first musical instrument.

6. The system of claim 1, wherein the first musical instrument and second musical instrument comprise electronic piano keyboards.

7. The system of claim 1, wherein the instructions are further executable to cause the first device to display a code to be captured by the second device to enable a data stream of the first device to be associated with a data stream of the first device.

8. The system of claim 1, wherein the first user interface of the first device is usable to configure parameters for a lesson to cause the second user interface to update in accordance with parameters set on the first user interface.

9. The system of claim 1, wherein the second user interface of the second device enables selection from multiple video streams for display.

10. The system of claim 1, wherein the instructions are further executable to cause the system to associate a fourth data stream from a fourth device associated with a third user with the first data stream, second data stream, and third data stream such that one of the first device or third device receives the fourth data stream.

11. The system of claim 1, wherein at least one of the data streams comprises fingering data that indicates finger positions for playing the first musical instrument or the second musical instrument.

12. The system of claim 1, wherein at least one of the data streams comprises light hints data that causes the first musical instrument or the second musical instrument to indicate how to play the first musical instrument or the second musical instrument according to a musical score.

13. The system of claim 1, wherein the instructions are further executable to transmit a notification to both the first device and the third device to enable the first device and third device to receive data streams from each other.

14. The system of claim 1, wherein the data streams comprise messages that cause keyboard keys to illuminate.

15. The system of claim 1, wherein the data streams comprise messages that indicate levels of force applied to keys of the first musical instrument and/or second musical instrument.
